(19) United States
(12) Patent Application Publication
(10) Pub. No.: US 2007/0286099 A1
(43) Pub. Date: Dec. 13, 2007

(54) User Interface Elements for Mobile Device Feature Discovery and Backup Status

(75) Inventors: Carl J. Stocklein, Madison, WI (US); Konstantin Othmer, Mountain View, CA (US); Michael P. Ruf, Parkland, FL (US)

Correspondence Address: WORKMAN NYDEGGER, 60 EAST SOUTH TEMPLE, 1000 EAGLE GATE TOWER, SALT LAKE CITY, UT, 84111, US

(73) Assignee: CORE MOBILITY, Mountain View, CA (US)

(21) Appl. No.: 11/467,905

(22) Filed: Aug. 28, 2006

Related U.S. Application Data
(63) Continuation-in-part of application No. 11/129,152, filed on May 13, 2005.

(51) Int. Cl. H04L 12/16

(52) U.S. Cl. 370/259

(57) ABSTRACT

Systems and methods for enabling user discovery of a service of a communication device. The services of a communications device are tracked or monitored for usage. A service that is unused or undiscovered is identified. Applications associated with the services are also tracked and monitored for usage. When an application is in use and there is an associated service that is unused, a discovery indicator is displayed on the communication device informing the user of the availability of the unused service. The user can select the discovery indicator to obtain additional information about the unused service.

### CROSS-REFERENCE TO RELATED APPLICATIONS

This application is a continuation-in-part application of U.S. patent application Ser. No. 11/129,152, filed May 13, 2005, and entitled “System and Methods for Discovering Features in a Communication Device,” which application is incorporated by reference herein in its entirety.

### BACKGROUND OF THE INVENTION

1. Field of the Invention

The present invention relates generally to communications systems, methods and devices. More particularly, embodiments of the invention relate to systems and methods for enabling user discovery of a feature on a mobile communication device.

2. Related Technology

The popularity of the Internet has given rise to a wide variety of information services and devices as consumers have become accustomed to accessing timely, personalized news and information. As a result, demand for these types of content and services as well as the communication devices through which the content and services are accessed continues to grow. In addition to the growth of the content and services that can be accessed using communication devices, cellular telephones and other communication devices are becoming increasingly sophisticated and offer a wide variety of different services. Voice dialing, picture messaging, voice memo, speakerphone, and text-to-speech capabilities are examples of some of the services that are found on current communication devices.

However, along with the offering of an increased number of features for mobile communication devices, product manufacturers have had difficulty informing consumers about the availability of these features and also educating consumers on the benefits of using the features. Usually, features are accessible via a “menu” interface. However, even if the user views a menu option for a certain feature, the user does not necessarily know what function the feature performs and how the feature can most efficiently be used. Often, features can be accessible only after accessing two or three layers of menu options, and users may not take the time to peruse all of the menu options of their mobile communication devices. Activation of a feature may require additional steps such as contacting a manufacturer, purchasing additional hardware, downloading additional software, and the like, that make using a particular feature difficult.

The above disadvantages of the difficulties of finding and using offered features will be described using the example of an offered data backup feature. Because of the increasing number of ways in which mobile communication devices can be used, the amount of information contained on mobile communication devices can be quite large. Often, some users store all of their organizational information, such as contacts, calendar, task list, personal notes, etc., on their mobile communication devices so that this information can be conveniently accessed anywhere. Unfortunately, many of these users do not perform data backup or may not realize that their mobile communication devices have the ability to perform this function. Thus, the data backup functionality of their devices may remain unused, leaving the valuable information susceptible to being lost due to system crashes, theft of the mobile communication device, and the like.

Furthermore, the difficulty of locating and operating data backup features of mobile communication devices often prevents users from synchronizing their data. For example, many mobile communication devices require the user to place the communication device in a cradle and then push a “backup” or “sync” button to initiate backup of data between the mobile communication device and another storage device (such as a user's computer or laptop). Alternatively, the data backup service may be located underneath various layers of menu options, requiring the user to go through two or more steps to initiate data backup. In some cases, users must contact a vendor or manufacturer to subscribe to a data backup service and then download additional software. Even after the software is installed, the user is not notified of the status of a backup. Thus, ascertaining the status of data backup may require multiple steps, often proving more of an inconvenience to a user, and compelling the user to choose to leave data unprotected.

### BRIEF SUMMARY

These and other limitations are overcome by embodiments of the invention, which relate to systems and methods for discovering a service on a mobile communication device in a simple and efficient manner. In general, embodiments of the invention are concerned with (1) determining how a mobile communication device user employs a feature or service of the device, and (2) providing interface indicators and other mechanisms to enable user discovery of the feature or service, including availability, benefits information and correct usage tips. For example, in one embodiment, the main display of a mobile communication device may include discovery features for allowing a user to discover a service. In addition, discovery can be achieved by integrating the discovery process with the navigation and interaction of the device. In this way, users are encouraged to take advantage of services which benefits both the users and the service providers.

While the present invention extends to any service or feature on a mobile communication device, exemplary embodiments of the invention include a data synchronization and backup service located on the communication device. (For convenience, “data synchronization and backup service” is hereinafter referred to as “data backup service.”) The data backup service communicates with a remote storage device to backup the data between the communication device and the remote storage device. The data backup occurs when data on the device changes. In addition, the data backup can occur automatically when the communication device is detected to be online. The data backup can occur over a wireless connection, which eliminates the need for unnecessary hardware, such as cradles or USB cords. Users can also access their data remotely from a remote storage device using any suitable browser application, including a browser application on the communication device.

Embodiments of the invention enable discovery of an unused data backup service by monitoring or tracking the usage of the communication device's data backup service, or by tracking whether the user has subscribed to the service. A data backup service is considered to be “unused” if it is either fully unused (i.e., not used in the past), infrequently used, or used incorrectly. A user is considered a subscriber of the service if the device is configured to automatically backup data using the service. A discovery indicator is rendered on a display of the communication device when the data backup service is unused. The discovery indicator can be, in one embodiment, an interactive ticker or a graphical image either on the main display of the device or as part of the iconic representation of the data on the device.

The user can select the discovery indicator using the communication device's navigational mechanisms. A number of different options may be presented to the user, such as initiating a data backup process, subscribing to the data backup service, receiving a tutorial or instructions about the data backup service, receiving a brief description of the data backup service, viewing an advertisement about the data backup service, and the like. In one embodiment, the discovery indicator allows the user to subscribe to or initiate data backup in as little as a single click.

In one embodiment, discovery of the data backup service can be associated with the operation of an application. In other words, the potential discovery indicator that is displayed as a result of the use of an application is related to both the undiscovered feature and the use of the application. In this sense, the application can be considered to be related to or associated with the discovered feature, and may herein be referred to as a “related application” or “associated application.” In addition, discovery of the data backup service can further be dependent upon a trigger condition being met when operating the application. For example, after entering two or three contact entries, the discovery indicator may be displayed when using the application, informing the user that contact information can be made more secure by using a data backup service and can instruct the user how to initiate or subscribe to the data backup service. This indicator can appear as an icon, a window, a dialog, or some other user interface element presented to the user.

When the data backup service requires a particular network, the discovery indicator appears on the display only if that particular network is detected by the communication device. In this manner, the discovery indicator gives the user the ability to immediately use the data backup service when it is available and while the idea is fresh in the user's mind.

After the user has initiated the use of the previously undiscovered data backup service, the discovery indicator is no longer displayed. The discovery indicator is redisplayed if the data backup service falls into nonuse or infrequent use, the subscription is cancelled, or the services are used incorrectly.

These and other aspects of embodiments of the present invention will become more fully apparent from the following description and appended claims.

### BRIEF DESCRIPTION OF THE DRAWINGS

To further clarify the above and other features of the present invention, a more particular description of the invention will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a schematic view illustrating aspects of an exemplary operating environment for embodiments of the invention;

FIG. 2 illustrates exemplary aspects of data backup client software;

FIG. 3 is a schematic view illustrating examples of navigation mechanisms on a communication device;

FIG. 4 is a flow chart illustrating an exemplary method for discovering a data backup service of a communication device; and

FIG. 5 is a flow chart illustrating another exemplary method for discovering a data backup service of a communication device.

### DETAILED DESCRIPTION

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

In general, embodiments of the invention are concerned with (1) determining how a mobile communication device (hereinafter “communication device”) user employs a feature or service of the device, and (2) providing interface indicators and other mechanisms to enable user discovery of the feature or service, including availability, benefits information and correct usage tips. For example, in one embodiment, the main screen or main display (hereinafter “main display”) of a mobile communication device may include discovery features for allowing a user to discover a service. In addition, discovery can be achieved by integrating the discovery process with the navigation and interaction of the device. These and other aspects of the invention will now be described in further detail.

### Operating Environments and Associated Devices

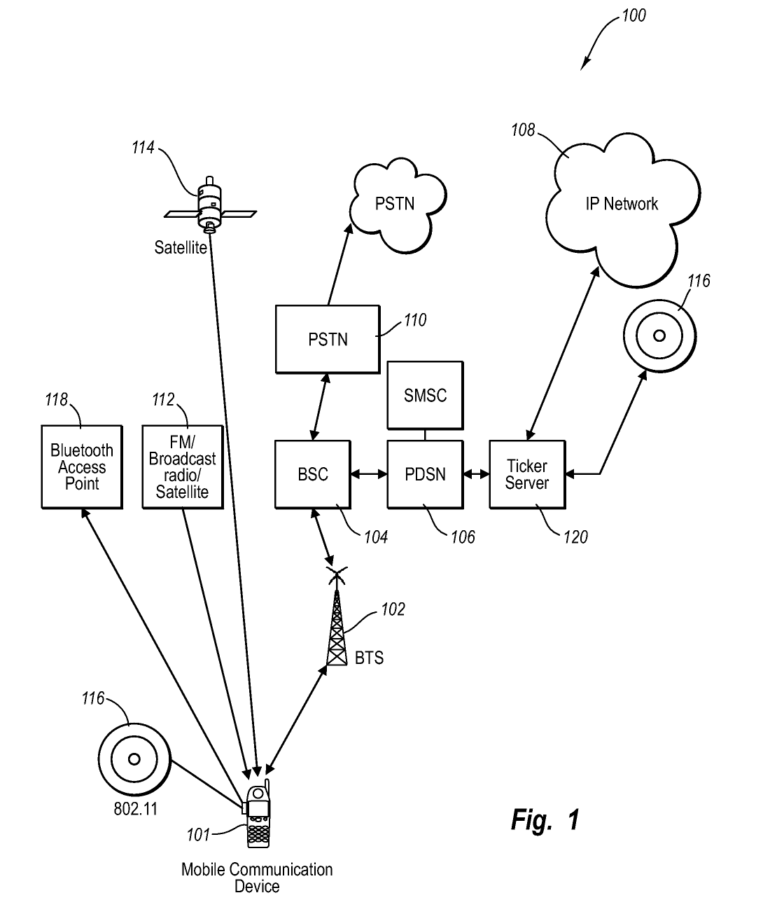

With particular attention now to FIG. 1, one exemplary implementation of an operating environment, denoted generally at 100, is indicated. Although this exemplary operating environment comprises multiple types of networks, including a cellular telephone network, 802.11 networks, Bluetooth access points, and broadcast networks such as FM radio or satellite radio, the invention may be employed in connection with any other type of network and associated landline or wireless communication devices that are effective in implementing or facilitating communication.

While FIG. 1 depicts a cellular telephone and exemplary embodiments are directed to the use of cellular telephones in conjunction with the invention, the invention should not be construed to be limited to such devices. Many types of communication devices are available and are suitable for use in conjunction with the invention, including set top boxes, cellular telephones, PDAs, smart phones, and many other devices suitably equipped to establish communication with a network and having a display device such as a display screen may be used to implement the methods of the invention. Accordingly, the scope of the invention should not be construed to be limited to the exemplary operating environment indicated in FIG. 1.

In the exemplary illustrated embodiment, the operating environment 100 includes one or more mobile communication devices 101 (also referred to herein as “mobile device(s)” and/or “communication device(s)”) configured to communicate with one or more networks and/or network elements, including base transceiver station (BTS) 102 of the cellular network, short messaging service (SMS) networks 106, internet protocol (IP) network 108, FM or satellite radio broadcast network 112, 802.11 wireless access points 116, and Bluetooth access point 118, or any other type of network, combination of networks, or network connections to which the communication device can connect and receive data transmissions. These data transmission modes are also referred to herein as “bearers”. One or more of these network elements or bearers may be used to transmit content to the communication device. 101. Mobile communication device 101 is optionally further configured with ticker client software that enables it, among other things, to communicate with ticker server 120 that may be embodied, in one implementation, as a server operating in conjunction with IP network 108. Ticker server 120 may further interface with other network elements, such as a Short Message Service Center (SMSC) and various gateways to implement the methods of the invention.

### Discovery and Notification of Unused Features or Services

While the present invention can extend to any service or feature located on a mobile communications device, the invention will be described herein primarily in the context of a “data synchronization and backup service,” hereinafter referred to as “data backup service.” Thus, while certain details may be specific to a data backup service, it will be appreciated that the broad concepts of discovering services and features both on the interface of the communications device and during interaction with the communications device can apply to any service or feature associated with the mobile communications device.

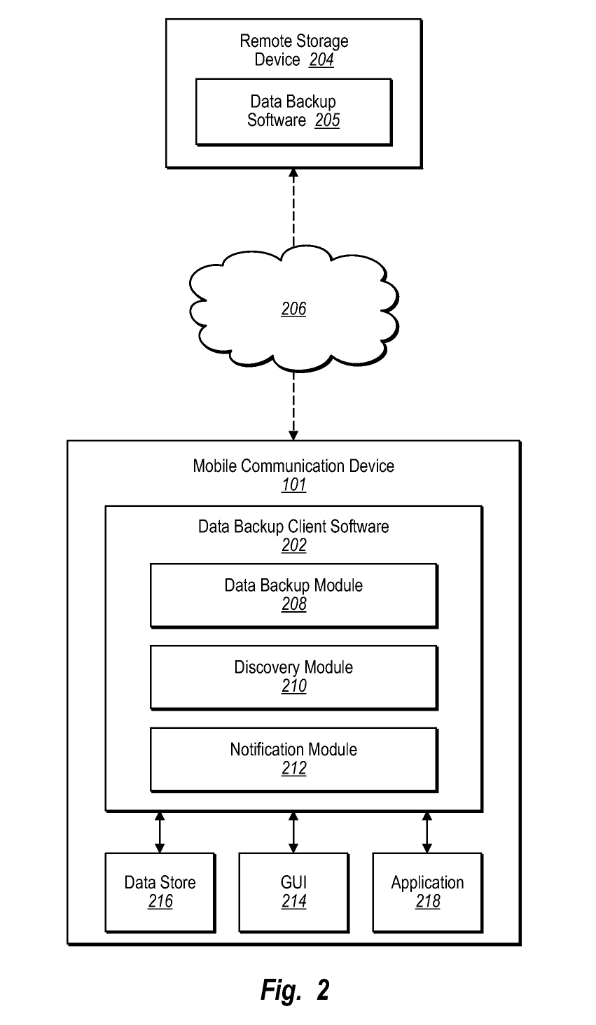

Turning to FIG. 2, details are provided concerning how the present invention performs data backup on a communication device. FIG. 2 and the accompanying discussion are presented to illustrate a suitable mobile communication device and associated data backup and synchronization service with which the methods for discovering services and features of a mobile communication device can be performed. The methods for promoting user discovery of services and features of communication devices and for notifying users of the availability of such services can be employed in a variety of networks and with a variety of mobile communication devices, and the embodiments illustrated in FIG. 2 are presented for purposes of illustrating the invention.

FIG. 2 illustrates an example of a system 200 having a communication device 101 communicating with a remote storage device 204. Data backup client software 202 resides on communication device 101 while data synchronization and/or data backup software (hereinafter “data backup software”) 205 resides on remote storage device 204. Remote storage device 204 can be, but is not limited to, data storage devices associated with servers, storage area networks (SANs), other computing devices, and the like. In addition to performing data backup processes, the data backup software 205 enables the user to view the data on the remote storage device 204 using a suitable browser application. The browser application used to access the data can reside on the communication device 101, itself.

The connection between the data backup client software 202 and remote storage device 204 can be formed via wired connection or a wireless connection. In some situations, the communication device 101 and remote storage device 204 can be in an “online” mode, in which the data backup client software 202 detects and/or connects to the network 206, or an “offline” mode in which the data backup client software 202 does not communicate with network 206. An “offline” and an “online” communication mode may also exist where the connection between the communication device 101 and remote storage device 204 is not a network, but rather, a non-network connection, such as a USB, IR, or other connection.

The data backup client software 202 includes a data backup module 208, a discovery module 210, and a notification module 212. The data backup client software 202 can further communicate with a graphical user interface 214, a data store 216 and one or more applications 218.

The data backup module 208 performs synchronization of data (e.g., in data store 216) stored on the communication device 101 with data that is stored on the remote storage device 204 and related to the communication device 101. The end result of data synchronization between the communication device 101 and the remote storage device 204 is to provide both devices with the most current set of data, whether that current data originally resided on the communication device 101 or the remote storage device 204. For example, the user may upload or otherwise provide updated or new contact information to remote storage device 204. The data backup service updates the data on the communication device 101 to reflect the changes made to the volume of data at the remote storage device 204 so that the user does not need to manually update the contact information on the communication device 101.

The data backup module 208 can be initiated automatically, for example, using an “automated backup” option set by the user. Alternatively, the data backup module 208 can be initiated manually by the user. In either case, when the data backup module 208 detects that the communication device 101 is online with the remote storage device 204, the data backup module commences to perform data backup and/or data synchronization between communication device 101 and remote storage device 204. In one embodiment, the data backup module 208 first determines whether a successful data backup has occurred in the past and whether a predetermined amount of time has passed since the previous successful data backup before proceeding with an automated data backup process. The data backup module 208 may log the progress of the data backup in data store 216.

Embodiments of the invention enable discovery of an unused data backup service by monitoring or tracking the usage of the communication device's data backup service. In this manner, users of mobile communication devices can easily learn of the availability of data backup services and to initiate use thereof. Users are encouraged to take advantage of data backup capabilities, which benefits both the users and the service providers. This is particularly useful because many users of mobile communication devices are not aware of data backup services or are unfamiliar with their use, and these problems can be alleviated using the methods described herein.

As defined herein, a data backup service is considered to be “unused” if it is either fully unused (i.e., not used in the past), infrequently used, used incorrectly, or if delivered as a service, anytime the user is not a subscriber of the service. The discovery module 210 monitors usage of the data backup service of communication device 101. In this way, the discovery module 210 identifies whether the data backup service of communication device 101 has been used. If the data backup service has not been used in any manner, if the user is not a subscriber, or if it has been used only infrequently or incorrectly, the data backup service is considered to be “unused.”

The discovery module 210 can also track the usage of particular aspects of the data backup service. For example, many devices have the ability to perform data backup. Many users, however, may be unaware that the data backup can be initiated in different ways. In the preferred embodiment, data backup occurs automatically once the user has subscribed to the service. In other embodiments, data backup can occur by setting an “automated data backup” menu option on the communication device. Alternatively, the user may be able to manually initiate a data backup using the communication device's menu regardless of when the previous successful data backup occurred.

The following example illustrates one way in which only a particular aspect of the data backup service is unused. In this example, the discovery module 210 monitors usage of the mobile communication device over time and determines that the user only used the manual option of starting a data backup process. With this observation, the discovery module 210 determines that the “automated data backup” aspect of the data backup service is considered to be “unused.” As illustrated in this example, the discovery module 210 can track and identify not only when the data backup service has not been used, but also identify unused aspects of the data backup service.

Discovery module 210 communicates with the notification module 212 to indicate when the data backup service is unused. Notification module 212 communicates with graphical user interface 214 to display a discovery indicator on a display of the communication device 101. The discovery indicator provides information that notifies the user of the fact that a service or feature, such as data backup service, is available, and encourages the user to take advantage of the service.

The notification module 212 determines the appropriate method of display and also the appropriate information to display. Selecting the method of display may include determining the display methods available on the communication device 101. Such methods may include displaying the discovery indicator in the form of an interactive ticker, graphical image, and the like. Selecting the appropriate information to display may involve communicating with the discovery module 210 to determine whether the entire service or only an aspect thereof is unused. For example, if only an aspect of the data backup service is unused, the discovery indicator is able to display content related to only that unused aspect.

In one embodiment, the graphical user interface 214 displays the discovery indicator via an interactive ticker. The graphical user interface may also use other means for displaying the discovery indicator, such as a graphical image using different colors or using different alphanumeric symbols. These methods for displaying the discovery indicator will now be described in further detail.

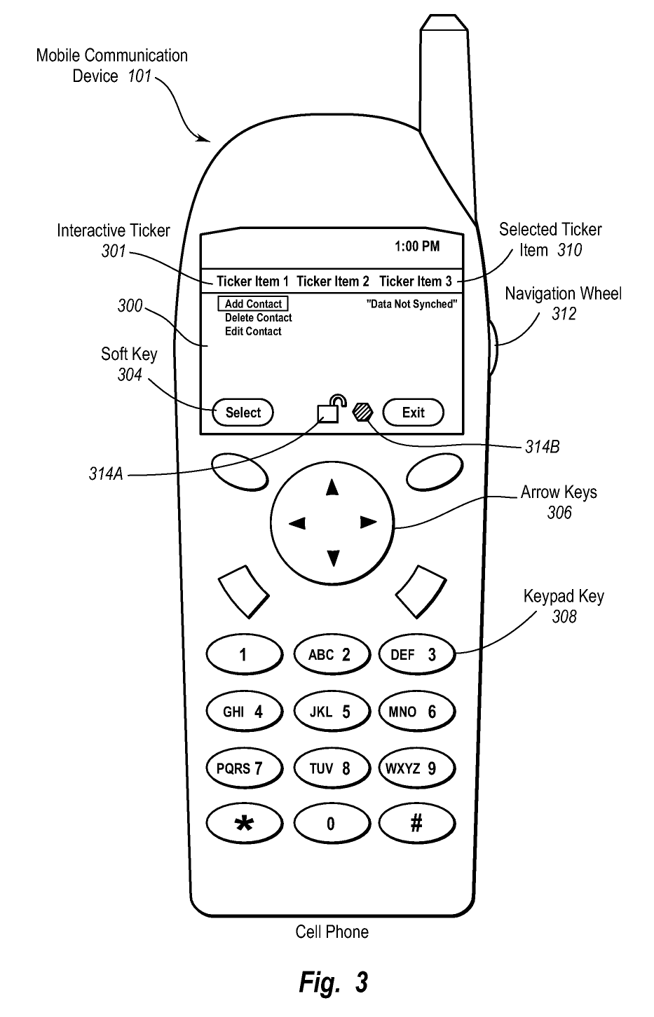

Turning now to FIG. 3, a schematic diagram of a communication device 101 and example navigation mechanisms are shown. The communication device 101 includes a display 300 having various display methods. Using keys on a keypad of the communication device 101 or on a remote control device associated with the communication device, soft keys, other device buttons and wheels, voice commands, or by moving the communication device in a particular way, such as shaking it, turning it from side to side or upside down, or otherwise moving the communication device, the user interacts with the content on display 300. For convenience, these navigation mechanisms are hereinafter referred to collectively as “navigation mechanism(s).” Such navigation mechanisms include, but are not limited, to arrow keys 306, navigation wheel 312, soft keys 304 and alphanumeric keys 308 illustrated in FIG. 3.

One display method is an interactive ticker 301 located, in this example, at the top of the display 300 of the communication device 101. As used herein, the term “ticker” refers to a portion of a display screen on a communication device in which information is dynamically displayed. The content displayed within the interactive ticker may also be referred to herein as “ticker item(s) 310.” In other words, the ticker items in the interactive ticker correspond to content, and some of the ticker items correspond to the data backup service of the communication device. In this manner, information about the data backup service of the communication device can be presented to the user in an interactive ticker 301 on the display of the communication device.

In FIG. 3, the ticker item #3 includes a discovery indicator, with content indicating, for example, “Data Not Synched.” This is but one example of content that can be included in a discovery indicator. Including the discovery of the data backup service as ticker item #3 is an unobtrusive way to alert the user that there is a potential problem with the security of the user's data. The decision to display a discovery indicator in ticker 301 can also depend on which bearers are available to the communication device 101 at a given time. For example, if a network is not available, the notification module 212 may choose to not display a message, such as “Data Not Synched.” Of course, the discovery indicator can be displayed in the ticker at any time, without regard to the presence of a network, simply to notify the user of the existence of the data backup service.

In some cases, navigating to and selecting a ticker item causes an additional action to be performed, such as presenting supplemental information that expands on the subject of the ticker item, launching an application resident on the communication device, causing additional content, applications, or services to be downloaded to the communication device or accessed by the communication device, or causing any of a number of other actions to be performed. For example, if the selected ticker item corresponds to “Data Not Synched,” additional content may appear, describing how to use the data backup service or providing further information regarding its existence. This information can be obtained locally from the mobile communication device or remotely. Additional details and examples of interactive tickers with which embodiments of the present invention can be used are provided in U.S. patent application Ser. No. 10/916,960, filed Aug. 11, 2004, which is incorporated herein by reference.

In another embodiment illustrated in FIG. 3, the notification module 212 renders the discovery indicator in the form of a graphical image 314. Multiple discovery indicators may be displayed on display 300 at the same time, each discovery indicator relating to a different feature or service. However, for purposes of describing the present invention, multiple discovery indicators related to the data backup service are displayed to illustrate the various ways in which they can be displayed.

The graphical image 314 is any pictorial or alphanumeric symbol that suitably conveys information about the data backup service. In the example of FIG. 3, an image of a lock in an “unlocked mode” 314A is flashed on the display 300 to communicate the message, “unsecure” or “data not backed up.” In another example, an image of an octagon 314B may be displayed in the color red (indicated by shading) to indicate that the data backup service is unused. As such, the discovery indicator may implement a combination of graphical images and/or colors. The graphical images can be navigated and selected in the same manner as the ticker items described herein.

The discovery indicator can thus serve two purposes: (1) to notify a user that a service exists, and (2) to notify the user of the status of a particular service. For example, in addition to notifying a user that a data backup service exists, the wording or color may further serve to indicate to the user the status of the data backup service. Displaying “Data Not Synched” in a ticker, a graphical image of a lock in an “unlocked mode,” or an octagon flashing a red color can all serve to indicate that the data backup service has not been initiated. In this sense, the discovery indicator also serves as a data synchronization status indicator.

If the user is interested in using or learning more about the data backup service, the user selects the appropriate discovery indicator. In response, notification module 212 provides a number of different options to encourage the use of the data backup service. For example, the notification module 212 can display a brief description of the data backup service on the display, an option to immediately activate the data backup service, an option to view a tutorial relating to the data backup service, an advertisement related to the data backup service, an option to exit the notification relating to the availability of the data backup service, or the like.

For example, the notification module 212 may launch a tutorial that gives step-by-step instructions for using or activating a data backup service. The tutorial guides the user through an actual use of the data backup service or simulates such use. The instructions or tutorial can be located locally on the communication device 101 or remotely (e.g., downloaded from ticker server 120). The instructions or tutorial for the data backup service can be graphical and/or textual in nature. For example, the tutorial can take any number of forms, such as text, video, WAP page, MMS, audio walk-through, or other means of communicating with the user.

If the data backup service is subsequently engaged by the user, this action is noted by the discovery module 210 and reflected in the data backup service usage data. Advantageously, displaying the availability of the data backup service in an unobtrusive way on the display 300 gives users the opportunity to learn to use the data backup service without having to consult the communication device's manual.

In one embodiment, the notification module 212 displays the discovery indicator in conjunction with an application 218. In the embodiment of FIG. 3, the discovery indicator is displayed concurrently with an application currently operating on the communication device. The application can be any audiovisual and/or multimedia application such as, but not limited to, a recent/missed calls utility, a voice mail utility, a messaging utility (e.g., voice mail, text messaging, multimedia messaging, instant messaging), a networking utility, an address book, a calendar, a task utility, a note/memo utility, a game utility, a settings utility, and the like. In this example, the application is an organizational information application. The organizational information application can be used to organize a user's contacts, calendar items, tasks, memos, and the like. In the example of FIG. 3, the user interacts with an organizational information application by inputting contact information into the communication device. The display 300 illustrates that the user is entering a contact entry.

As the user is operating the application, the ticker item #3 displays a discovery indicator in the form of, “Secure contact information, click here.” As such, the discovery indicator is displayed in the context of an application in which this particular service or functionality would be particularly desirable. The discovery indicator notifies the user of the availability of the data backup service to backup the user's organizational information and can instruct the user to initiate the data backup by using one of the communication device's navigational mechanisms (e.g., by selecting an “OK” soft key). After the data backup process is performed, the display 300 then provides the user with other options related to the data backup service and/or the related application, such as offering to teach the user a more efficient way to enter contact information via a Web form that collects and sends the data to a server instead of entering the information through the communication device.

Thus, in addition to monitoring the usage of the data backup service, the notification module 212 can also determine whether an application 218 is being used. Upon determining that the application 218 is being used and that the data backup service is unused, the notification module 212 causes a discovery indicator to appear on the graphical user interface 214 regarding the availability of the data backup service.

In one embodiment, where the data backup service requires a particular network 206, the discovery indicator appears on the display 300 of the communication device 101 only if that particular network is detected by the communication device. Displaying the discovery indicator when the corresponding network 206 is detected gives the user the ability to immediately use the data backup service while the idea is fresh in the user's mind. Of course, discovery indicators can instead be displayed on display 300 without regard to the current availability of a network.

Once a user has discovered and used the data backup service, there is no longer a need to provide reminders regarding the data backup service. In this case, the graphical user interface 214 can be dedicated to displaying notifications of the status of data backup rather than the discovery of data backup. In this case, the discovery indicator changes to a data synchronization status indicator and can use the same means for displaying the current state of the data.

In one embodiment, the graphical user interface 214 displays the data synchronization status indicator via an interactive ticker. The ticker could also display the data synchronization status using different colors, such as “blue” for “data synchronization initiated,” “orange” for “data synchronization in progress,” “green” for “data synchronization complete,” or “yellow” for “data synchronization incomplete” or “red” for “data not synchronized.” The graphical user interface may also use other means for displaying the data synchronization status, such as a graphical image of a lock in an unlocked and locked position or in different colors, or using different alphanumeric symbols. Additional details relating to using a data synchronization status indicator are provided in co-pending U.S. patent application Ser. No. ______, filed ______, and entitled “User Interface Indicator For Mobile Telephone Backup Status,” which application is incorporated herein by reference in its entirety.

If, however, the data backup service is later unused for some period of time, then the discovery module 210 may cause a discovery indicator to reappear on the display 300 of the communication device 101 or while the user is interacting with application 218.

While the invention has been described above in the context of a data backup service, the present invention broadly covers any discoverable feature or service of the communication device including, but not limited to, broadband access, picture messaging, text messaging, voice messaging, text-to-speech, voice dialing, speakerphone, abbreviated dialing, active dialing, music purchasing, location-based services, calendaring, security, voice memo, quick dialing, data backup, data synchronization, data transfer, as well as other existing services, and the like or any combination thereof. Embodiments of the invention can also accommodate new services. In embodiments where discovery notification of the service occurs while the user is interacting with an application 218, the application 218 can be any of the services listed above as well as any other application.

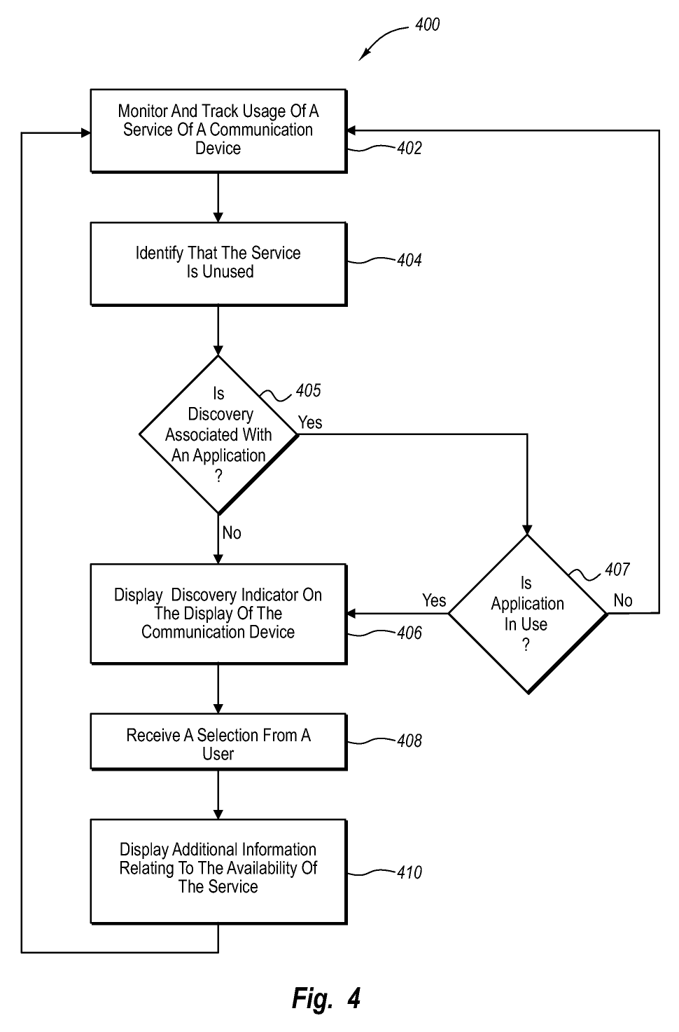

FIG. 4 illustrates an example of a method 400 for discovering a service of a communication device. In the following example, a data backup service will be used to illustrate aspects of method 400. However, it will be understood that the same methodology can apply to discovering any feature or service on a communication device. At 402, the discovery module 210 of the communication device is monitoring and tracking the usage of the data backup service of the communication device. This can include identifying how often a data backup service is used, when the data backup service is used, or whether only certain aspects of the data backup service are used.

At 404, the discovery module 210 determines that the data backup service is unused. Determining that the data backup service is unused may also include determining that the user has used the data backup service infrequently or incorrectly, or that the user is not subscribed to the data backup service. Determining that the data backup service is unused can also include identifying unused aspects of the data backup service.

At 405, the discovery module 210 determines whether the data backup service is associated with an application 218. In other words, by identifying an association between the data backup service (or undiscovered feature) and an application in use, the potential discovery indicator is selected that relates to both the application in use and the undiscovered feature. In this sense, the application can be considered to be related to or associated with the discovered feature, and may herein be referred to as a “related application” or “associated application.” In this embodiment, the identification of this association is performed by the discovery module 210. However, a separate module can be included to perform solely the function of identifying the association between the undiscovered feature and the application.

At 406, if the data backup service is associated with an application 218, the notification module 212 displays a discovery indicator relating to the availability of the data backup service on a display of the communication device. This can include mapping the unused data backup service to descriptions and tutorials related to the data backup service. The discovery indicator can be included on the display 300 of the communication device 101 as an interactive ticker item, a graphical image, and the like, as described hereinabove. The notification module 212 may further monitor whether an online connection to a particular network 206 is required to perform the data backup service and optionally may elect not to display the notification item if the communication device 101 is offline.

At 407, if the data backup service is associated with an application 218, the discovery module determines whether the application 218 is currently in use. If the application 218 is currently in use, method 400 returns to 406 where the discovery indicator is displayed on the display of the communication device. However, if the application 218 is not in use, the method 400 returns to 402 to continually monitor the usage of one or more services.

Thus, the discovery indicator can be displayed when the data backup service is unused without the user being required to interact with the communications device, or when the user is operating an application. In either case, at 408, a user employs navigation mechanisms to select a discovery indicator, such as a ticker item or a graphical image, which corresponds to an unused data backup service. At 410, information relating to the data backup service is presented to the user, and can include a brief description of the data backup service, an option to immediately activate the data backup service, an option to view a tutorial relating to the data backup service, an advertisement related to the data backup service, an option to exit the notification relating to the availability of the data backup service, and the like. If the tutorial is completed or not completed, this can be noted by the discovery module 210 and taken into account for future use.

The process returns to 402 to continue monitoring and tracking the usage of the data backup service and may take into account user actions, such as any subsequent user action based on the options provided at 410. In some instances, the user may discover and use the data backup service without viewing the tutorial or without selecting a discovery indicator from the display 300. The discovery module 210, however, tracks this usage of the data backup service and updates the data store 216 accordingly to take this independent discovery by the user into account in determining the unused status of the data backup service.

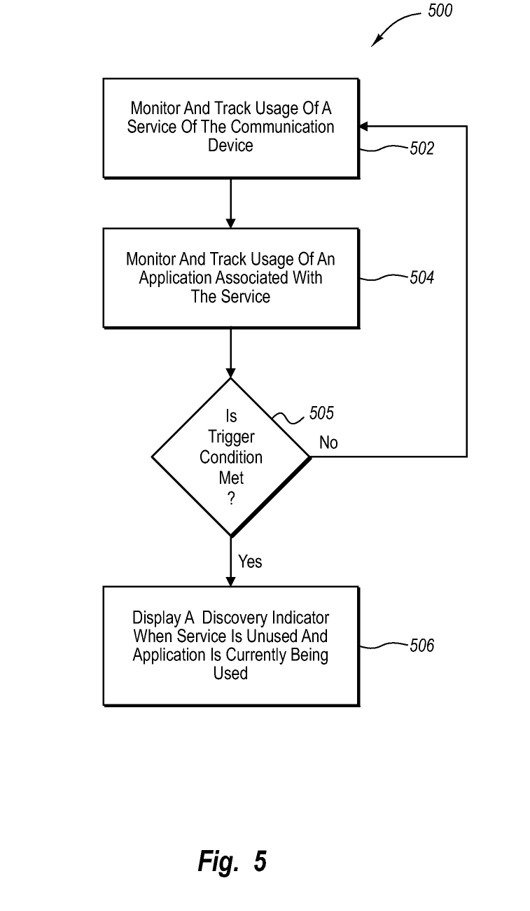

FIG. 5 illustrates another embodiment of a method 500 of notifying a user of the availability of a feature or service, such as a data backup service, while the user is interacting with an application 218. At 502, the discovery module 210 of the communication device is monitoring and tracking the usage of the service of the communication device. At 504, the discovery module 210 also monitors and tracks the usage of an application 218 associated with or related to the service.

At 505, discovery module 210 determines whether a trigger condition is met. In the example where the application 218 is an organizational information application, a user interacts with the application 218 to input organizational information such as contact information. An example of a trigger condition is when a certain number of contacts have been entered into communication device, such as three contact entries, ten contact entries, 25 contact entries, 100 contact entries, etc. Another trigger condition can be a certain amount of elapsed time that a user has been interacting with a particular application 218. Other trigger conditions can be configured as understood by those in the art upon learning the features of the present invention.

At 506, the notification module 212 displays a discovery indicator relating to the availability of the service (1) when the service is “unused,” (2) when the application is currently being used, and (3) when the trigger condition is met. If the trigger condition is not met, the method 500 returns to 502 to continually monitor the usage of one or more services.

Including the discovery indicator of an unused service on the display 300 of the communication device 101 facilitates the discovery process for several reasons. A user who actively selects a discovery indicator is expressing interest in learning about the service. The tutorial launched by the selection of the discovery indicator is crafted for that specific service. At the same time, a user who does not want to learn about the service can simply choose to not select the discovery indicator. However, the user is still made aware of the existence of the service and may come back to it at some time in the future. In this manner, the discovery of a service does not interrupt the usage of the communication device while still providing the opportunity to discover important services.

Thus, conventionally, the user may have been unaware that the user's mobile device contained the functionality to perform features or services, such as data backup. The present invention simplifies the discovery process of features and services for the user. Rather than having to search through layers of menu options to locate a feature or service, the present invention provides that information in a readily accessible form via the discovery indicator. The discovery indicator can provide varying levels of information about the feature or service functionality, even allowing a user to immediately initiate the feature or service, such as a data backup process, with a single click.

Furthermore, features and services like the data backup functionality have conventionally been unavailable when operating an application. The present invention provides the ability to monitor applications that are related to a particular service. When the service is unused and when the related application is in use (e.g., the user is interacting with the application), the present invention provides for a discovery indicator to appear within the related application (e.g., a ticker item or a graphical image), notifying the user of the availability of a certain service. Advantageously, this apprises users of additional functionalities that may enhance the user's experience in operating a specific application, feature or service.

### Telecommunication Devices and Computing Environments

Embodiments of the present invention may be implemented in connection with a special purpose or general purpose telecommunications device, including wireless telephones and other telephony-enabled wireless devices, landline telephones, or special purpose or general purpose computers that are adapted to have telecommunications or data networking capabilities such as cable set top boxes or PCs. Embodiments within the scope of the present invention also include computer-readable media for carrying or having computer-executable instructions or electronic content structures stored thereon, and these terms are defined to extend to any such media or instructions that are used with telecommunications devices.

By way of example, and not limitation, such computer-readable media can comprise RAM, ROM, EEPROM, CD-ROM or other optical disk storage, magnetic disk storage or other magnetic storage devices, or any other medium which can be used to carry or store desired program code in the form of computer-executable instructions or electronic content structures and which can be accessed by a general purpose or special purpose computer, or other computing device.

When information is transferred or provided over a network or another communications connection (either wired, wireless, or a combination of wired or wireless) to a computer or computing device, the computer or computing device properly views the connection as a computer-readable medium. Thus, any such a connection is properly termed a computer-readable medium. Combinations of the above should also be included within the scope of computer-readable media. Computer-executable instructions comprise, for example, instructions and content which cause a general purpose computer, special purpose computer, special purpose processing device or computing device to perform a certain function or group of functions.

Although not required, aspects of the invention have been described herein in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

We claim:

1. A method for discovering a service on a mobile communications device, the method comprising:
monitoring a service to determine when the service is not being used by a user;
monitoring an application associated with the service to identify when the application is being used by a user; and
displaying a discovery indicator on a display of the mobile communication device while the application is being used.

2. A method as defined in claim 1, wherein monitoring a service to determine when the service is not being used by a user further comprises tracking the service to determine at least one of:
that the user is not subscribed to the service;
that the service is used infrequently;
that the service is used incorrectly; or
an undiscovered aspect of the service.

3. A method as defined in claim 1, wherein displaying a discovery indicator on a display of the mobile communication device further comprises displaying the discovery indicator using at least one of an interactive ticker, a dialog, or a graphical image.

4. A method as defined in claim 1, further comprising, in response to receiving a selection from a user through one or more navigational mechanisms of the mobile communication device to select the discovery indicator, displaying at least one of:
a brief description of the service;
an option to immediately activate the service;
an option to view a tutorial relating to the service;
an advertisement related to the service; or
an option to exit the notification relating to the availability of the service.

5. A method as defined in claim 1, wherein the service is associated with a particular network, further comprising displaying a discovery indicator on a display of the mobile communication device while the application is being used only when the particular network is detected.

6. A method as defined in claim 1, wherein the service is at least one of: broadband access, picture messaging, text messaging, voice messaging, text-to-speech, voice dialing, speakerphone, abbreviated dialing, active dialing, music purchasing, location-based services, calendaring, security, voice memo, quick dialing, data backup, PC connectivity, or data transfer.

7. A method as defined in claim 1, wherein the discovery indicator displays a status of the service.

8. A method as defined in claim 1, wherein the application is at least one of a recent/missed calls utility, a voice mail utility, a messaging utility (e.g., voice mail, text messaging, multimedia messaging, instant messaging), a networking utility, an address book, a calendar, a task utility, a note/memo utility, a game utility, or a settings utility.

9. A method for enabling a user to discover a service associated with an application of a communication device, the method comprising:
monitoring a service to determine when the service is not being used by a user;
determining whether a trigger condition associated with the service has been met; and
displaying a discovery indicator on a display of the mobile communication device if the trigger condition has been met.

10. A method as defined in claim 9, wherein monitoring a service to determine when the service is not being used by a user further comprises tracking the service to determine at least one of:
whether the user is a subscriber for the service;
whether the service is used infrequently;
whether the service is used incorrectly; or
an undiscovered aspect of the service.

11. A method as defined in claim 9, wherein displaying the content related to the unused service on a display of the mobile communication device if the trigger condition has been met further comprises at least one of:
displaying a brief description of the unused service on the display;
displaying an option to immediately activate the unused service;
displaying an option to view a tutorial relating to the unused service;
displaying an advertisement related to the unused service; or
displaying an option to exit the notification relating to the availability of the unused service.

12. A method as defined in claim 11, wherein presenting an option to immediately activate the unused service further comprises:
receiving input from the user through one or more navigational mechanisms of the mobile communication device to immediately activate the unused service; and
presenting instructions through at least the display of the device that teaches the user how to activate the unused service.

13. A method as defined in claim 11, wherein displaying an option to view a tutorial relating to the unused service further comprises accessing the tutorial from at least one of the mobile communication device or a remote storage device.

14. A method as defined in claim 9, wherein the service is one or more of: broadband access, picture messaging, voice messaging, text messaging, text-to-speech, voice dialing, speakerphone, abbreviated dialing, active dialing, music purchasing, location-based services, calendaring, security voice memo, quick dialing, data backup, and data transfer.

15. A method as defined in claim 9, wherein the discovery indicator displays the status of the service.

16. A method for discovering a data backup service on a mobile communications device, the method comprising:
monitoring a data backup service to determine when the data backup service is not being used by a user;
monitoring an application associated with the data backup service to identify when the application is being used by a user; and
displaying a data backup discovery indicator on a display of the mobile communication device while the application is being used.

17. A method as defined in claim 16, wherein monitoring a data backup service to determine when the data backup service is not being used by a user further comprises tracking the data backup service to determine at least one of:
that the user is subscribed to the data backup service;
that the data backup service is used infrequently;
that the data backup service is used incorrectly; or
an undiscovered aspect of the data backup service.

18. A method as defined in claim 16, wherein displaying a data backup discovery indicator on a display of the mobile communication device further comprises displaying the data backup discovery indicator using at least one of an interactive ticker or a graphical image.

19. A method as defined in claim 16, further comprising, in response to receiving a selection from a user through one or more navigational mechanisms of the mobile communication device to select the data backup discovery indicator, displaying at least one of:
a brief description of the data backup service;
an option to immediately activate the data backup service;
an option to view a tutorial relating to the data backup service;
an advertisement related to the data backup service; or
an option to exit the notification relating to the availability of the data backup service.

20. A method as defined in claim 16, wherein the data backup service is associated with a particular network, further comprising displaying a data backup discovery indicator on a display of the mobile communication device while the application is being used only when the particular network is detected.

21. A method as defined in claim 16, further comprising determining whether a trigger condition associated with the user of the application has been met.

22. A method as defined in claim 21, further comprising displaying a data backup discovery indicator on a display of the mobile communication device while the application is being used only if the trigger condition has been met.

23. A method as defined in claim 16, wherein the data backup discovery indicator displays a status of the data backup service.

24. A method as defined in claim 16, wherein the application is at least one of a recent/missed calls utility, a voice mail utility, a messaging utility (e.g., voice mail, text messaging, multimedia messaging, instant messaging), a networking utility, an address book, a calendar, a task utility, a note/memo utility, a game utility, or a settings utility.
